(19) United States
(12) Patent Application Publication
(10) Pub. No.: US 2022/0255057 A1
(43) Pub. Date: Aug. 11, 2022

(54) Modulation of Electroplated Surface Features Based on Monitored Electrical Noise

(71) Applicant: Pure Lithium Corporation, Charlestown, MA (US)

(72) Inventor: Donald R. Sadoway, Cambridge, MA (US)

(21) Appl. No.: 17/581,545

(22) Filed: Jan. 21, 2022

Related U.S. Application Data
(60) Provisional application No. 63/148,422, filed on Feb. 11, 2021.

(51) Int. Cl. H01M 4/1395; H01M 4/38; C25D 7/00; H01M 4/134; H01M 4/02; H01M 10/052

(52) U.S. Cl. CPC H01M 4/1395; H01M 4/382; H01M 10/052; H01M 4/134; H01M 2004/027; C25D 7/00

(57) ABSTRACT

Systems and methods are proposed for controlling the electroplating of lithium metal onto negative electrodes to allow for more rapid recharging of lithium metal batteries while minimizing dendrite formation. Based on the power spectrum of the electrochemical noise, characteristic signals of dendrite formation are monitored, and when these signals are observed, alternating and direct current voltages are modulated in order to vitiate dendrite formation.

### CROSS-REFERENCE TO RELATED APPLICATIONS

This patent application claims the benefit of U.S. Provisional Patent Application No. 63/148,422 filed Feb. 11, 2021, the disclosure of which is incorporated by reference herein in its entirety.

### TECHNICAL FIELD

The present invention relates to systems and methods for modulating the surface features of metals electrodeposited on conductive substrates. Aspects of the invention relate to minimizing dendrite growth during secondary battery charging, in particular for lithium metal batteries.

### BACKGROUND ART

Lithium metal batteries have intrinsically higher capacity than lithium ion batteries, and are thus the preferred technology for primary batteries. However, rechargeable lithium metal batteries tend to form dendrites on the lithium metal electrode, which can short batteries, leading to reduced battery life and the potential for hazardous combustion.

Lithium metal electrodes comprise a flat conductive substrate, typically copper, that functions as a negative electrode, onto which lithium metal is deposited.

During electrodeposition on an electrode surface, nonuniform current distributions may occur at defects and/or result from random processes. Stochastic variations in current and voltage over time and space on the electrode may in turn lead to uneven distribution of deposited lithium, and eventually can promote dendrite formation. Dendrite formation during recharging places limits both on battery lifetime and on the speed at which batteries can be recharged. In order to increase battery lifetime and efficiency, and to reduce charging times, a need exists for inexpensive methods to monitor and control dendrite formation during battery charging.

### SUMMARY OF THE EMBODIMENTS

When a direct current voltage is applied across a negative electrode and a positive electrode of an electrolytic cell, monitoring electrical noise during electrodeposition of metal onto the cathode and analyzing its frequency dependence provides signatures of the growth of surface structural features of the deposited metal. When the time dependence of electrical noise during this electrodeposition is Fourier transformed to provide a power spectrum of the noise, characteristic frequency components can be identified as a “frequency signature” indicative of the formation of particular structural features of the metal thus deposited. In particular, frequency signatures characteristic of dendrite formation can be identified. One such frequency signature of dendrite formation is the occurrence of anomalously large frequency contributions to the spectral density in the range of 0.05 to 0.2 Hz.

According to an aspect of the present invention, when a frequency signature of dendrite formation is observed during dc electrolytic deposition of metal onto the cathode of an electrolytic cell, dendrite formation can be reversed by (a) modulating the magnitude and direction of a dc current across positive and negative electrodes of an electrolytic cell, and (b) applying an ac current of controlled magnitude and frequency across the anode and the cathode of the electrolytic cell. In particular embodiments, dendrite formation can be reversed by applying ac frequency components corresponding to the ac frequency components observed in the spectral density function and/or by reversing the polarity of the applied dc voltage.

In accordance with some embodiments of the invention, a system is configured for monitoring and controlling electrolytic deposition of metal in an electrolytic cell, the electrolytic cell including a positive electrode, a negative electrode, and an electrolyte providing a source of metal ions for electrodeposition onto the negative electrode, the system having:

(1) a variable direct current (dc) voltage source configured to receive a first control signal, and to provide a dc voltage across the positive electrode and the negative electrode of the electrolytic cell based on the first control signal;

(2) a variable alternating current source configured to receive a second control signal, and to provide alternating current across the positive electrode and the negative electrode based on the second control signal;

(3) an electrochemical noise monitor configured to monitor current and voltage across the positive electrode and the negative electrode and to produce an output signal indicative of the current and voltage noise across the positive electrode and the negative electrode;

(4) an analysis and control system configured to receive the output signal, and to analyze the output signal to calculate a power spectrum of the noise, and further configured to output the first control signal to the variable dc voltage source, and the second control signal to the variable alternating current generator, the first control signal and the second control signal being determined based on user-determined input parameters and on the power spectrum of the noise; and

(5) a configuration of the system such that, during operation, the dc voltage and the alternating current control the surface features of the metal electrodeposited on the negative electrode based on the first control signal and the second control signal, respectively.

In an embodiment, the system is configured such that the first control signal determines the magnitude and direction of the dc voltage. In an embodiment, the second control signal determines the magnitude and frequency of the alternating current.

In an embodiment, the metal electrodeposited on the negative electrode comprises lithium. In an embodiment, the electrolytic cell is a rechargeable lithium metal battery.

In an embodiment, the metal electrodeposited on the negative electrode comprises aluminum. In an embodiment, the electrolytic cell is a rechargeable aluminum metal battery.

In some embodiments, the system is configured such that, during operation, the dc voltage and the alternating current are controlled by the first control signal and the second control signal in order to reduce dendrite formation. In some embodiments the system is configured such that the dc voltage is reversed in order to reduce dendrite formation. In some embodiments the system is configured such that the alternating current is applied with frequency components corresponding to frequency components of the electrical noise in order to reduce dendrite formation. In some such embodiments the system is configured such that the dc voltage is set at zero during application of the alternating current. In some embodiments the system is configured such that the dc voltage is reversed during application of the alternating current.

In some embodiments, a method of monitoring and controlling electrolytic deposition of metal in an electrolytic cell includes:
(1) providing an electrolytic cell with a positive electrode, a negative electrode, and an electrolyte providing a source of metal ions for electrodeposition onto the negative electrode;
(2) connecting a variable direct current (dc) voltage source across the positive electrode and the negative electrode of the electrolytic cell;
(3) connecting a variable alternating current source across the positive and the negative electrode;
(4) connecting an electrochemical noise monitor across the positive electrode and the negative electrode, the electrochemical noise monitor being configured to monitor current and voltage and to produce an output signal indicative of the current and voltage noise across the positive electrode and the negative electrode;
(5) providing an analysis and control system in communication with the dc voltage source, the alternating current source, and the electrochemical noise monitor; and
   by means of the analysis and control system:
(6) receiving the output signal from the electrochemical noise monitor at the analysis and control system;
(7) calculating a power spectrum of the noise from the output signal;
(8) generating the first control signal to the variable dc voltage source, and the second control signal to the variable alternating current generator, the first control signal and the second control signal being determined based on user-determined input parameters and on the power spectrum of the noise;

wherein, during operation, the dc voltage and the alternating current control the surface features of the metal electrodeposited on the negative electrode based on the first control signal and the second control signal, respectively.

In some embodiments of the method, the dc voltage and the alternating current are controlled by the first control signal and the second control signal in order to reduce dendrite formation. In some embodiments of the method the dc voltage is reversed in order to reduce dendrite formation. In some embodiments of the method the alternating current is applied with frequency components corresponding to frequency components of the electrical noise in order to reduce dendrite formation. In some embodiments of the method, the dc voltage is set at zero during application of the alternating current. In some embodiments of the method, the dc voltage is reversed during application of the alternating current.

In accordance with some embodiments of the invention, a system is configured for monitoring and controlling electrolytic deposition of metal in an electrolytic cell, the electrolytic cell including a positive electrode, a negative electrode, and an electrolyte providing a source of metal ions for electrodeposition onto the negative electrode, the system having:

(1) a voltage source configured to receive a control signal, and, based on the control signal, to provide a variable dc voltage and a variable alternating current across a positive electrode and a negative electrode of the electrolytic cell;

(2) an electrochemical noise monitor configured to monitor current and voltage across the positive electrode and the negative electrode and to produce an output signal indicative of the current and voltage noise across the positive electrode and the negative electrode;

(3) an analysis and control system configured to receive the output signal, and to analyze the output signal to calculate a power spectrum of the noise, and further configured to output the control signal to the voltage source, the control signal being determined based on user-determined input parameters and on the power spectrum of the noise; and

(4) a configuration of the system such that, during operation, the dc voltage and the alternating current control the surface features of the metal electrodeposited on the negative electrode based on the control signal.

In some embodiments, a method of monitoring and controlling electrolytic deposition of metal in an electrolytic cell includes:
(1) providing an electrolytic cell with a positive electrode, a negative electrode, and an electrolyte providing a source of metal ions for electrodeposition onto the negative electrode;
(2) connecting a voltage source across the positive electrode and the negative electrode of the electrolytic cell, the voltage source configured to provide a variable dc voltage and a variable alternating current across the positive electrode and the negative electrode;
(3) connecting an electrochemical noise monitor across the positive electrode and the negative electrode, the electrochemical noise monitor being configured to monitor current and voltage and to produce an output signal indicative of the current and voltage noise across the positive electrode and the negative electrode;
(4) providing an analysis and control system in communication with the voltage source and the electrochemical noise monitor; and by means of the analysis and control system:
(5) receiving the output signal from the electrochemical noise monitor at the analysis and control system;
(6) calculating a power spectrum of the noise from the output signal;
(7) generating the control signal to the voltage source, the control signal being determined based on user-determined input parameters and on the power spectrum of the noise;

wherein, during operation, the dc voltage and the alternating current control the surface features of the metal electrodeposited on the negative electrode based on the control signal.

The embodiments of the invention described above are intended to be merely exemplary; numerous variations and modifications will be apparent to those skilled in the art. All such variations and modifications are intended to be within the scope of the present invention as defined in any appended claims.

### BRIEF DESCRIPTION OF THE DRAWINGS

The foregoing features of embodiments will be more readily understood by reference to the following detailed description, taken with reference to the accompanying drawings, in which:

FIG. 1 provides a schematic diagram of a method of controlled electroplating according to an embodiment of the invention

FIG. 2 provides a diagram of an electroplating system according to an embodiment of the invention.

### DETAILED DESCRIPTION OF SPECIFIC EMBODIMENTS

Definitions. As used in this description and the accompanying claims, the following terms shall have the meanings indicated, unless the context otherwise requires:

A “positive electrode” is the anode in an electrolytic cell, and the cathode in a galvanic cell.

A “negative electrode” is the cathode in an electrolytic cell and the anode in a galvanic cell. Consequently, a lithium metal electrode in a lithium metal battery is always a “negative electrode” even though it is a cathode during charging and an anode during discharging.

In the context of this application, a “lithium metal electrode” and a “lithium electrode” are synonymous, and each refers to a negative electrode comprising lithium metal.

A “lithium metal battery” (or “LMB”) is a battery that utilizes a negative electrode comprising pure lithium metal (i.e. a lithium metal electrode).

“Charging” of a lithium metal battery is the process of electrolytically depositing lithium metal on the negative electrode of the battery.

“Discharging” of a lithium metal battery is the process of connecting the battery to an external circuit and allowing current to flow between the positive and the negative electrodes, thereby providing a source of electrical energy that can be used to perform work.

“Noise” is the fluctuation of a signal with time compared to the mean of the signal.

A “power spectrum” is the Fourier transform of the autocorrelation function of a time domain signal into the frequency domain. In the present context, the power spectrum represents the conversion of voltage fluctuations in time (“noise”) into the frequency dependence of voltage fluctuations.

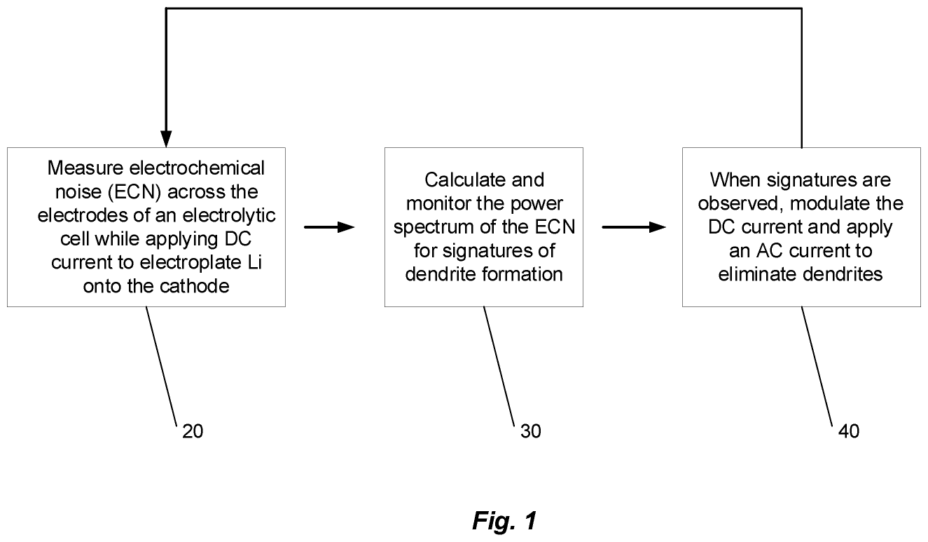

An embodiment of the method of the current invention is provided in FIG. 1. Electrochemical noise is measured as dc voltage is applied to electroplate lithium. 20. A power spectrum is calculated from the noise and monitored for signatures of dendrite formation. 30. When signatures of dendrite formation are observed, the dc current is modulated and/or an alternating current is applied across the electrodes to eliminate dendrites. 40. The electrochemical noise is then monitored again 20 and the process 30, 40 repeated as the cell is charged, thereby eliminating dendrites as they form.

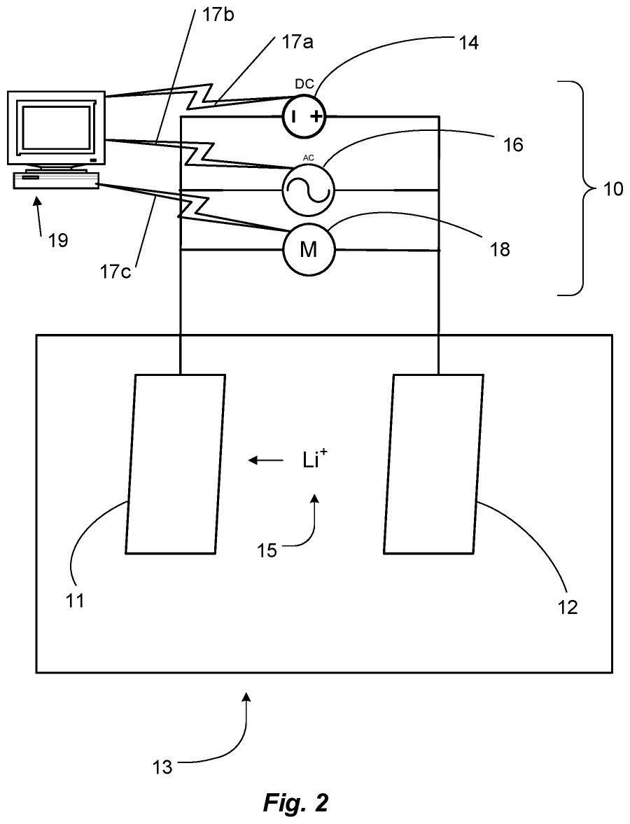

FIG. 2 provides an embodiment of a system 10 for monitoring and controlling the electrolytic deposition of metal for an electrolytic cell 13 according to the present invention. A direct current (dc) power supply 14 provides a dc voltage across a negative electrode 11 and a positive electrode 12 of the electrolytic cell 13. The dc charging current provides electrons to the negative electrode 11 and withdraws electrons from the positive electrode 12. During this process, lithium ions 15 migrate towards the negative electrode 11, and combine with the electrons to form lithium metal, which is electrodeposited on the negative electrode 11. Also connected across the positive electrode 12 and the negative electrode 11 are an alternating current (ac) voltage source 16 and an electrochemical noise monitor 18. The dc power supply 14, the ac voltage source 16 and the electrochemical noise monitor 18 are each communicably coupled 17a, 17b, 17c, respectively, to a controller 19.

The electrochemical noise monitor 18 measures the voltage as a function of time across the electrodes, and sends an output signal proportional to that voltage to the controller 19. After subtracting the mean value of the signal, the controller 19 divides the time dependent noise signal into time domain windows and, in each window subjects the remaining noise fluctuation signal to fast Fourier transform, thereby providing a series of voltage versus frequency signals (power spectra) for each successive time domain window. In a preferred embodiment, the time domain window is between 1 to 20 seconds. In a preferred embodiment, the time domain window ranges from 5 seconds to 10 seconds. The controller 19 monitors the successive power spectra for characteristic frequency signatures of dendrite formation. When the power spectra show such dendrite signatures, the controller sends a first control signal to the dc power supply 14 and a second control signal to the ac voltage source 16. The first control signal directs the dc power supply to change magnitude and/or direction in order to reverse dendrite formation. The second control signal directs the ac voltage source to provide an appropriate ac current in order to reverse dendrite formation.

In some embodiments, in the absence of dendrite formation the decay of correlation of the noise is exponential and the power spectra are Lorentzian lineshapes. Deviations from Lorentzian behavior provide the characteristic signatures of dendrite formation and other electrochemical phenomena. Such deviations may include peaks at specific frequencies. In a particular embodiment, peaks at between 0.05 and 0.2 Hz provide characteristic signatures of dendrite formation.

In a preferred embodiment, the second control signal directs the ac voltage source to input ac power with absolute magnitude that is no greater than 10% of the magnitude of the dc power. In a preferred embodiment, the input ac voltages are provided at the dendrite signature frequencies of the power spectrum.

In some embodiments, the first control signal directs the dc voltage source to temporarily reverse polarity, thereby preferentially removing electroplated dendrites.

In some embodiments, a constant ac ripple current is applied during electrodeposition, and as dendrite signatures appear in the spectral density, the ac ripple current is modulated by additional ac frequencies in order to vitiate dendrite formation.

The embodiments of the invention described above are intended to be merely exemplary; numerous variations and modifications will be apparent to those skilled in the art. All such variations and modifications are intended to be within the scope of the present invention as defined in any appended claims.

What is claimed is:

1. A system configured for monitoring and controlling electrolytic deposition of metal in an electrolytic cell, the electrolytic cell including a positive electrode, a negative electrode, and an electrolyte providing a source of metal ions for electrodeposition onto the negative electrode, the system comprising:
a variable direct current (dc) voltage source configured to receive a first control signal, and to provide a dc voltage across the positive electrode and the negative electrode based on the first control signal;
a variable alternating current source configured to receive a second control signal, and to provide alternating current across the positive electrode and the negative electrode based on the second control signal;
an electrochemical noise monitor configured to monitor current and voltage across the positive electrode and the negative electrode and to produce an output signal indicative of the current and voltage noise across the positive electrode and the negative electrode;
an analysis and control system configured to receive the output signal, and to analyze the output signal to calculate a power spectrum of the noise, and further configured to output the first control signal to the variable dc voltage source, and the second control signal to the variable alternating current source, the first control signal and the second control signal being determined based on user-determined input parameters and on the power spectrum of the noise,
wherein the system is configured such that, during operation, the dc voltage and the alternating current control the surface features of the metal electrodeposited on the negative electrode based on the first control signal and the second control signal, respectively.

2. The system according to claim 1, the first control signal determining the magnitude and direction of the dc voltage.

3. The system according to claim 1, the second control signal determining the magnitude and frequency of the alternating current.

4. The system according to claim 1, wherein the metal electrodeposited on the negative electrode comprises lithium.

5. The system according to claim 1, wherein the electrolytic cell is a rechargeable lithium metal battery.

6. The system according to claim 1, wherein, during operation, the dc voltage and the alternating current are controlled by the first control signal and the second control signal in order to reduce dendrite formation.

7. The system according to claim 6, wherein, during operation, the dc voltage is reversed in order to reduce dendrite formation.

8. The system according to claim 6, wherein, during operation, the alternating current is applied with frequency components corresponding to frequency components of the electrical noise in order to reduce dendrite formation.

9. The system according to claim 8, wherein, during operation, the dc voltage is set at zero during application of the alternating current.

10. The system according to claim 8, wherein, during operation the dc voltage is reversed during application of the alternating current.

11. A method of monitoring and controlling electrolytic deposition of metal in an electrolytic cell comprising:
providing an electrolytic cell,
the electrolytic cell including:
a positive electrode, a negative electrode, and an electrolyte providing a source of metal ions for electrodeposition onto the negative electrode;
connecting a variable direct current (dc) voltage source across the positive electrode and the negative electrode of the electrolytic cell;
connecting a variable alternating current source across the positive and the negative electrode;
connecting an electrochemical noise monitor across the positive electrode and the negative electrode, the electrochemical noise monitor being configured to monitor current and voltage and to produce an output signal indicative of the current and voltage noise across the positive electrode and the negative electrode;
providing an analysis and control system in communication with the dc voltage source, the alternating current source, and the electrochemical noise monitor;
by means of the analysis and control system:
receiving the output signal from the electrochemical noise monitor at the analysis and control system;
calculating a power spectrum of the noise from the output signal;
generating the first control signal to the variable dc voltage source, and the second control signal to the variable alternating current source, the first control signal and the second control signal being determined based on user-determined input parameters and on the power spectrum of the noise,
wherein, during operation, the dc voltage and the alternating current control the surface features of the metal electrodeposited on the negative electrode based on the first control signal and the second control signal, respectively.

12. The method according to claim 11, wherein the dc voltage and the alternating current are controlled by the first control signal and the second control signal in order to reduce dendrite formation.

13. The method according to claim 12, wherein the dc voltage is reversed in order reduce dendrite formation.

14. The method according to claim 12, wherein the alternating current is applied with frequency components corresponding to frequency components of the electrical noise in order to reduce dendrite formation.

15. The method according to claim 14, wherein the dc voltage is set at zero during application of the alternating current.

16. The method according to claim 14, wherein the dc voltage is reversed during application of the alternating current.

17. A system configured for monitoring and controlling electrolytic deposition of metal in an electrolytic cell, the electrolytic cell including a positive electrode, a negative electrode, and an electrolyte providing a source of metal ions for electrodeposition onto the negative electrode, the system comprising:
a voltage source configured to receive a control signal, and, based on the control signal, to provide a variable dc voltage and a variable alternating current across the positive electrode and the negative electrode;
an electrochemical noise monitor configured to monitor current and voltage across the positive electrode and the negative electrode and to produce an output signal indicative of the current and voltage noise across the positive electrode and the negative electrode;
an analysis and control system configured to receive the output signal, and to analyze the output signal to calculate a power spectrum of the noise, and further configured to output the control signal to the voltage source, the control signal being determined based on user-determined input parameters and on the power spectrum of the noise,
wherein the system is configured such that, during operation, the dc voltage and the alternating current control the surface features of the metal electrodeposited on the negative electrode based on the control signal.

18. A method of monitoring and controlling electrolytic deposition of metal in an electrolytic cell comprising:
providing an electrolytic cell,
the electrolytic cell including:
a positive electrode, a negative electrode, and an electrolyte providing a source of metal ions for electrodeposition onto the negative electrode;
connecting a voltage source across the positive electrode and the negative electrode, the voltage source configured to provide a variable dc voltage and a variable alternating current across the positive electrode and the negative electrode;
connecting an electrochemical noise monitor across the positive electrode and the negative electrode, the electrochemical noise monitor being configured to monitor current and voltage and to produce an output signal indicative of the current and voltage noise across the positive electrode and the negative electrode;
providing an analysis and control system in communication with the voltage source and the electrochemical noise monitor;
by means of the analysis and control system:
receiving the output signal from the electrochemical noise monitor at the analysis and control system;
calculating a power spectrum of the noise from the output signal;
generating the control signal to the voltage source, the control signal being determined based on user-determined input parameters and on the power spectrum of the noise,
wherein, during operation, the direct current voltage and the alternating current control the surface features of the metal electrodeposited on the negative electrode based on the control signal.

19. The system according to claim 1, wherein the metal electrodeposited on the negative electrode comprises aluminum.

20. The system according to claim 1, wherein the electrolytic cell is a rechargeable aluminum metal battery.
